(19) United States
(12) Patent Application Publication
(10) Pub. No.: US 2026/0302434 A1
(43) Pub. Date: Oct. 1, 2026

(54) SECONDARY BATTERY

(71) Applicant: SAMSUNG SDI CO., LTD., Yongin-si (KR)

(72) Inventor: Eun Kang LEE, Yongin-si (KR)

(21) Appl. No.: 19/300,892

(22) Filed: Aug. 15, 2025

(30) Foreign Application Priority Data
Mar. 31, 2025 (KR) 10-2025-0041001

(51) Int. Cl. H01M 50/103; H01M 50/15; H01M 50/533; H01M 50/536; H01M 50/54; H01M 50/586

(52) U.S. Cl. CPC H01M 50/103; H01M 50/15; H01M 50/533; H01M 50/536; H01M 50/54; H01M 50/586; H01M 2220/20

(57) ABSTRACT

Disclosed is a secondary battery. The secondary battery includes an electrode assembly including a first electrode, a separator, and a second electrode, wherein the first electrode, the separator, and the second electrode are alternately stacked, a case configured to accommodate the electrode assembly and including a long-side portion extending in the stacking direction of the electrode assembly and short-side portions connected to two opposite ends of the long-side portion, the short-side portions having a smaller area than the long-side portion, a cap plate coupled to the case to seal the case, and a terminal unit mounted on the cap plate and electrically connected to each of the first electrode and the second electrode. Two opposite end surfaces of the electrode assembly that are perpendicular to the stacking direction are adjacent to the short-side portions of the case.

### CROSS-REFERENCE TO THE RELATED APPLICATION

The present application claims priority to and the benefit of Korean Patent Application No. 10-2025-0041001, filed on Mar. 31, 2025, in the Korean Intellectual Property Office, the entire disclosure of which is incorporated herein by reference.

### BACKGROUND

### 1. Field

Embodiments relate to a secondary battery.

### 2. Description of the Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles. The secondary battery includes an electrode assembly consisting of a positive electrode and a negative electrode, a case accommodating the same, and electrode terminals connected to the electrode assembly.

The above information disclosed in this Background section is only for enhancement of understanding of the background of the disclosure and therefore it may contain information that does not constitute prior art.

### SUMMARY

Embodiments provide a secondary battery capable of addressing the issue of reduced structural stability of a case and a battery resulting from swelling of an electrode assembly during charging and discharging processes.

Embodiments provide a secondary battery capable of enhancing current transfer efficiency and reducing heat generation by minimizing contact resistance generated during electrical connection between an electrode assembly and a terminal unit. The secondary battery is also capable of improving electrical stability by optimizing the structural arrangement of current collectors and electrode tabs.

However, the technical problems to be achieved in the embodiment of the disclosure are not limited to the technical problems mentioned above, and other technical problems not mentioned herein will be clearly understood from the following description by those skilled in the art to which the disclosure belongs.

A secondary battery according to an embodiment of the present disclosure includes an electrode assembly including a first electrode, a separator, and a second electrode, wherein the first electrode, the separator, and the second electrode are alternately stacked, a case configured to accommodate the electrode assembly and including a long-side portion extending in the stacking direction of the electrode assembly and short-side portions connected to two opposite ends of the long-side portion, the short-side portions having a smaller area than the long-side portion, a cap plate coupled to the case to seal the case, and a terminal unit mounted on the cap plate and electrically connected to each of the first electrode and the second electrode.

In some examples, two opposite end surfaces of the electrode assembly that are perpendicular to the stacking direction may be adjacent to the short-side portions of the case.

In some examples, the secondary battery may further include a first current collector located between the electrode assembly and the cap plate, the first current collector extending in the stacking direction of the electrode assembly, and the first current collector electrically connected to a first electrode tab of the first electrode and a terminal of the terminal unit.

In some examples, the first current collector may have a rectangular plate shape.

In some examples, the secondary battery may further include a second current collector located between the electrode assembly and the cap plate, the second current collector extending in the stacking direction of the electrode assembly, and the second current collector electrically connected to a second electrode tab of the second electrode and a second terminal of the terminal unit.

In some examples, the second current collector may have a rectangular plate shape.

In some examples, the first current collector and the second current collector may be located parallel to the stacking direction of the electrode assembly.

In some examples, the first tab and the second tab may protrude toward the cap plate.

In some examples, the case may include connection portions located on two opposite sides of the long-side portion in the width direction, wherein the connection portions are mounted perpendicular to the long-side portion, such that the connection portions interconnect the short-side portions.

In some examples, the first electrode, the separator, and the second electrode may be formed in a rectangular plate shape.

In some examples, the first electrode, the separator, and the second electrode may be mounted perpendicular to the long-side portion and may be alternately stacked.

In some examples, the first electrode may include an edge divided into long sides and short sides according to a length, and one of the long sides, which are longer than the short sides, may be adjacent to the long-side portion.

In some examples, the second electrode may include an edge divided into long sides and short sides according to a length, and one of the long sides, which are longer than the short sides, may be adjacent to the long-side portion.

In some examples, the cap plate and the long-side portion may be formed to have the same area.

In some examples, the first electrode may be a positive electrode, and the second electrode may be a negative electrode.

In some examples, the first current collector and the second current collector may be connected to the first tab and the second tab, respectively, by welding.

A secondary battery according to another embodiment of the present disclosure includes an electrode assembly including a first electrode, a separator, and a second electrode, wherein the first electrode, the separator, and the second electrode are alternately stacked, a case configured to accommodate the electrode assembly and including a long-side portion extending in the stacking direction of the electrode assembly and short-side portions connected to two opposite ends of the long-side portion, the short-sided portions having a smaller area than the long-side portion, a cap plate coupled to the case to seal the case, a terminal unit mounted on the cap plate and electrically connected to each of the first electrode and the second electrode, and an insulating member mounted between the electrode assembly and the case, the insulating member further mounted between the electrode assembly and the cap plate and formed of an insulating material, wherein two opposite end surfaces of the electrode assembly that are perpendicular to the stacking direction, the two opposite end surfaces are adjacent to the short-side portions of the case.

In some examples, the insulating member may include an end insulating portion mounted between the electrode assembly and each of the short-side portions of the case

In some examples, the insulating member may include a side insulating portion mounted between the electrode assembly and the long-side portion of the case and between the electrode assembly and connection portions of the case.

In some examples, the insulating member may include an inner insulating portion mounted between the electrode assembly and the cap plate, the inner insulating portion.

In some examples, the secondary battery may further include a first current collector located between the electrode assembly and the cap plate, the first current collector extending in the stacking direction of the electrode assembly, the first current collector electrically connected to a first tab of the first electrode and a first terminal of the terminal unit, and a second current collector located between the electrode assembly and the cap plate, the second current collector extending in the stacking direction of the electrode assembly, the second current collector electrically connected to a second tab of the second electrode and a second terminal of the terminal unit.

### BRIEF DESCRIPTION OF THE DRAWINGS

The following drawings attached to this specification illustrate preferred embodiments of the present disclosure and serve to further understand the technical idea of the present disclosure together with the detailed description of the present disclosure, and thus, the present disclosure should not be construed as being limited to the matters described in such drawings. In the drawings:

FIG. 1 is a perspective view showing an example of a secondary battery according to an embodiment of the present disclosure;

FIG. 2 is an exploded perspective view showing an example of the secondary battery according to an embodiment of the present disclosure;

FIG. 3 is an exploded perspective view showing an example of an electrode assembly of the secondary battery according to an embodiment of the present disclosure;

FIG. 4 is a perspective view showing an example of the electrode assembly, a first current collector, and a second current collector of the secondary battery according to an embodiment of the present disclosure;

FIG. 5 is a perspective view showing an example of a state in which the first current collector and the second current collector are fixed to the electrode assembly with a cap plate separated therefrom in the secondary battery according to an embodiment of the present disclosure;

FIG. 6 is a plan view showing an example of the electrode assembly mounted in a case of the secondary battery according to an embodiment of the present disclosure;

FIG. 7 is a side cross-sectional view showing an example of the secondary battery according to an embodiment of the present disclosure;

FIG. 8 is an exploded perspective view showing an example of a secondary battery according to an embodiment of the present disclosure;

FIG. 9 is a side cross-sectional view showing an example of the secondary battery according to an embodiment of the present disclosure;

FIG. 10 is a front cross-sectional view showing an example of the secondary battery according to an embodiment of the present disclosure;

FIG. 11 is a plan view showing an example of a battery module according to an embodiment of the present disclosure;

FIG. 12 is a front view showing an example of the battery module according to an embodiment of the present disclosure;

FIGS. 13 and 14 are perspective views showing examples of a battery pack including an exemplary secondary battery according to the present disclosure; and

FIGS. 15 and 16 are, respectively, a perspective view and a side view showing examples of a vehicle including an exemplary battery pack according to the present disclosure.

### DETAILED DESCRIPTION OF EXEMPLARY EMBODIMENTS

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application. In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the disclosure, the attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

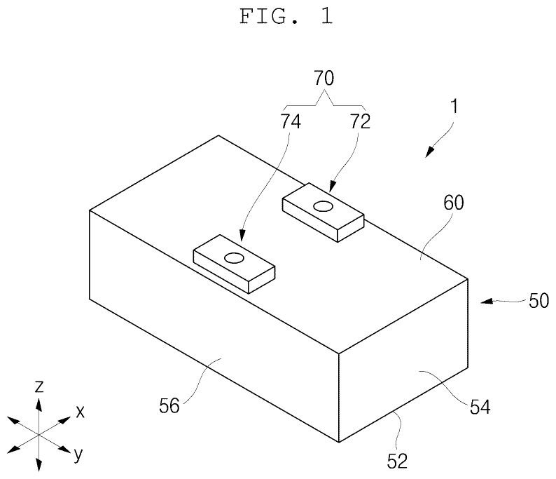

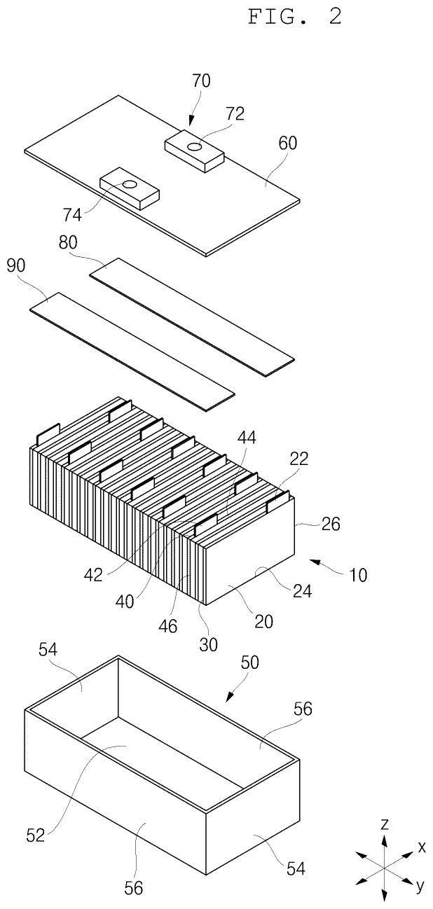

FIG. 1 is a perspective view showing an example of a secondary battery 1 according to an embodiment of the present disclosure, and FIG. 2 is an exploded perspective view showing an example of the secondary battery 1 according to an embodiment of the present disclosure. As shown in FIGS. 1 and 2, the secondary battery 1 according to an embodiment of the present disclosure may include an electrode assembly 10, a case 50, a cap plate 60, a terminal unit 70, a first current collector 80, and a second current collector 90.

The present disclosure provides a technique for reducing swelling of the electrode assembly 10, which may occur during charging and discharging of the secondary battery 1, and for improving structural stability.

The case 50 may be formed in a shape of a box having an open top and may include a long-side portion 52 and short-side portions 54. The long-side portion 52 may define a bottom of the case 50, and the short-side portions 54 may be perpendicularly connected to the long-side portion 52, thereby forming a structure having a relatively small area and high rigidity. As an example, the long-side portion 52 may be the bottom of a rectangular box, with the short-side portions 54 the end pieces of that rectangular box. In the present disclosure, the electrode assembly 10 may be located such that two opposite end surfaces thereof in the longitudinal direction face the short-side portions 54, thereby enabling control of expansion of the electrode assembly 10 through the short-side portions 54 rather than the long-side portion 52.

This structure improves both the structural stability and performance of the battery by effectively mitigating/suppressing swelling while maintaining the rigidity of the case 50. Furthermore, the present disclosure also provides a technical effect of reducing heat generation and enhancing current transfer efficiency through a design that improves an electrical connection structure between the electrode assembly 10 and the terminal unit 70 and promotes a uniform electrochemical reaction. The technique of the present disclosure is suitable for design of battery modules and packs that require enhanced safety while maintaining high energy density.

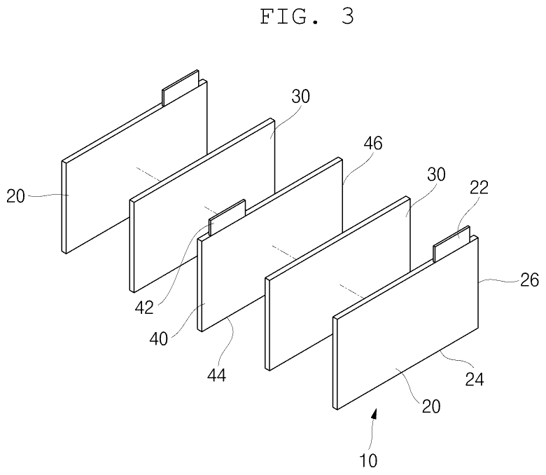

FIG. 3 is an exploded perspective view showing an example of the electrode assembly 10 of the secondary battery 1 according to an embodiment of the present disclosure. As shown in FIGS. 2 and 3, the electrode assembly 10 may include a first electrode 20, a separator 30, and a second electrode 40, which are alternately stacked (e.g., a first electrode 20, followed by a separator 30, followed by a second electrode 40, followed by another separator 30, then beginning the sequence again).

The electrode assembly 10 may be formed by winding or stacking a stack of the first electrode 20, the separator 30, and the second electrode 40, which are formed as a thin plate or film. If the electrode assembly 10 is formed by winding the stack, the winding axis thereof may be parallel to the longitudinal direction of the case 50. In other embodiments, the electrode assembly 10 may be of a stacked type rather than a wound type. The disclosure is not limited to any specific type of the electrode assembly 10. In other embodiments, the electrode assembly 10 may be a Z stack electrode assembly 10 in which the separator 30 is bent in a Z-shape and the first electrode 20 and the second electrode 40 are respectively inserted into both sides of the separator 30. In some embodiments, one or more electrode assemblies 10 may be stacked adjacent to each other, and the resulting stack may be accommodated in the case 50. However, the disclosure is not limited as to the number of electrode assemblies 110. The first electrode 20 of the electrode assembly 10 may serve as a positive electrode, and the second electrode 40 of the electrode assembly 10 may serve as a negative electrode. In other embodiments, the reverse may also be possible.

In some examples, the first electrode 20, the separator 30, and the second electrode 40 may be formed in a rectangular plate shape. In some examples, the first electrode 20, the separator 30, and the second electrode 40 may be mounted perpendicular to the long-side portion 52 and alternately stacked. The first electrode 20, the separator 30, and the second electrode 40 may be mounted to stand upright on the long-side portion 52 that defines the bottom surface of the case 50.

The first electrode 20 may be formed by applying a first electrode active material, such as graphite or carbon, to a first electrode current collector, which is formed as a metal foil made of copper, a copper alloy, nickel, or a nickel alloy. A first tab 22 provided on the first electrode 20 may be electrically connected to the first current collector 80 of the current collecting unit.

The edge of the first electrode 20 may be divided into long sides 24 and short sides 26 according to the length. One of the long sides 24, which are longer than the short sides 26, may be located immediately next to the long-side portion 52 of the case 50 (i.e., the long side 24 of the first electrode 20 will be immediately next to the long-side portion 52 (the bottom of the rectangular case 50 as illustrated in FIG. 2)). The short sides 26 may be positioned on two opposite sides of the first electrode 20 in the width direction, and the long sides 24 may be positioned on two opposite sides of the first electrode 20 in the vertical direction. The short sides 26 and the long sides 24 may define the edge of the first electrode 20 that has a rectangular shape. The short sides 26 of the first electrode 20 may be adjacent to the short-side portions 54 of the case 50, and a lower one of the long sides 24 of the first electrode 20 may be adjacent to the long-side portion 52 of the case 50. An upper one of the long sides 24 of the first electrode 20 may be adjacent to the cap plate 60. The first tab 22 may be connected to the upper one of the long sides 24 of the first electrode 20. The first tab 22 may extend upward from the first electrode 20.

In the first electrode 20, a graphite or carbon active material may be uniformly applied to the first electrode plate, and the thickness of the active material may be designed in consideration of current density and capacity characteristics. The applied graphite or carbon active material may be mixed with a binder and a conductive material to form an electrode active material layer. The binder may serve to enhance the durability of the active material layer, and the conductive material may serve to improve the electrical conductivity of the active material layer.

In some examples, the binder may be formed from a material such as polyvinylidene fluoride (PVDF), styrene-butadiene rubber (SBR), or carboxymethyl cellulose (CMC), and the conductive material may be formed from a material such as carbon black, acetylene black, or graphene.

The first tab 22 of the first electrode 20 may be formed of a highly conductive metal such as copper or nickel to efficiently transfer current generated from the first electrode 20. The width and thickness of the first tab 22 may be designed to minimize electrical resistance and ensure welding stability. The first tab 22 may extend upward from the electrode assembly 10 and may be electrically connected to the first current collector 80.

An end of the first tab 22 may be located adjacent to the cap plate 60 and may be electrically connected to the first current collector 80 through welding or physical coupling. In some embodiments, the first tab 22 and the first current collector 80 may be designed to be connected by laser welding to ensure durability in a high-temperature environment.

The dimensions and shapes of the long sides 24 and the short sides 26 of the first electrode 20 may be optimized based on their respective positions to maintain uniformity in electrochemical reaction.

In some examples, the separator 30 may be located between the first electrode 20 and the second electrode 40 to prevent short circuit and to allow migration of lithium ions and may be formed from a polyethylene film, a polypropylene film, or a composite film of polyethylene and polypropylene. In other embodiments, the separator 30 may be replaced with an inorganic solid electrolyte, such as a sulfide-based, oxide-based, or phosphate compound-based solid electrolyte, that does not require a liquid-or gel-type electrolyte.

The second electrode 40 may be formed by applying a second electrode active material, such as a transition metal oxide, to a second electrode current collector, which is formed as a metal foil made of aluminum or an aluminum alloy. The electrode assembly 10 may be accommodated in the case 50 together with an electrolyte. A second tab 42 provided on the second electrode 40 may be electrically connected to the second current collector 90 of the current collecting unit.

The edge of the second electrode 40 may be divided into long sides 44 and short sides 46 according to the length. The long sides 44, which are longer than the short sides 46, may be adjacent to the long-side portion 52. The short sides 46 may be positioned on two opposite sides of the second electrode 40 in the width direction, and the long sides 44 may be positioned on two opposite sides of the second electrode 40 in the vertical direction. The short sides 46 and the long sides 44 may define the edge of the second electrode 40 that has a rectangular shape. The short sides 46 of the second electrode 40 may be adjacent to the short-side portions 54 of the case 50, and a lower one of the long sides 44 of the second electrode 40 may be adjacent to the long-side portion 52 of the case 50. An upper one of the long sides 44 of the second electrode 40 may be adjacent to the cap plate 60.

The first tab 22 may be connected to the upper one of the long sides 24 of the first electrode 20, and the second tab 42 may be connected to the upper one of the long sides 44 of the second electrode 40. The first tab 22 and the second tab 42 may protrude toward the cap plate 60.

The second electrode 40 may include a positive electrode active material, and an active material layer including a transition metal oxide may be uniformly applied to the second electrode plate. This active material layer may enable reversible insertion and extraction of lithium ions and may play a critical role in the energy density and cycle life of the battery.

In some examples, the active material of the second electrode 40 may be formed from a lithium transition metal composite oxide such as lithium nickel cobalt manganese oxide (LiNiCoMnO₂, NCM) or lithium nickel cobalt aluminum oxide (LiNiCoAlO₂, NCA). In other embodiments, a compound including lithium manganese oxide (LiMn₂O₄) or lithium iron phosphate (LiFePO₄) may be used. The composition of the selected active material may be designed to optimize the voltage characteristics and stability of the battery.

A binder used in the second electrode 40 may improve the durability of the active material layer, and a conductive material used in the second electrode 40 may optimize the electrical properties of the electrode. The binder may be formed from polyvinylidene fluoride (PVDF) or polytetrafluoroethylene (PTFE), and the conductive material may be formed from carbon black, carbon nanotubes (CNT), or graphene.

The second tab 42 provided on the second electrode 40 may be formed of aluminum or an aluminum alloy to provide a lightweight structure while ensuring high electrical conductivity. The width, thickness, and length of the second tab 42 may be designed in consideration of current density. The second tab 42 may maintain electrical balance within the electrode assembly 10. The second tab 42 may be connected to the second current collector 90 to efficiently transfer current to the external terminal unit 70.

The long sides 44 and the short sides 46 of the second electrode 40 may be designed to maintain uniformity in electrochemical reaction and to optimize current density and thermal distribution. The edge of the second electrode 40 may be finished with an insulating material or a protective coating to reduce the possibility of internal short circuit in the battery and to prevent mechanical damage.

In some embodiments, the active material layer of the second electrode 40 may be formed with a composition exhibiting excellent thermal stability to maintain stable characteristics in a high-temperature environment. For example, the composition of the lithium transition metal oxide may be controlled by adjusting the content of the transition metal, or a doping technique may be applied to enhance structural stability.

In some examples, the electrolyte may be formed from a lithium salt, such as LiPF₆ or LiBF₄, in an organic solvent, such as ethylene carbonate (EC), propylene carbonate (PC), diethyl carbonate (DEC), ethyl methyl carbonate (EMC), or dimethyl carbonate (DMC). For example, the electrolyte may be in a liquid or gel form. In some examples, if an inorganic solid electrolyte is used, the liquid or gel electrolyte may be omitted.

The case 50 may be formed in various shapes, as long as the case can accommodate the electrode assembly 10. In one embodiment of the present disclosure, the case 50 may be formed in a substantially hollow rectangular parallelepiped shape having an open top. The electrode assembly 10 may be inserted into the case 50 through the open top of the case 50. The case 50 may include a rectangular bottom surface and four side surfaces extending from the four sides of the bottom surface substantially in the vertical direction.

In some examples, the case 50 may include a long-side portion 52, short-side portions 54, and connection portions 56.

The long-side portion 52 may be referred to as a bottom surface of the case 50. The long-side portion 52 may accommodate the electrode assembly 10 and may extend in the stacking direction of the electrode assembly 10. The stacking direction of the electrode assembly 10 may be referred to as a longitudinal direction of the electrode assembly 10. The long-side portion 52, which has a rectangular plate shape, may extend in the longitudinal direction of the case 50.

The short-side portions 54 may be connected to two opposite ends of the long-side portion 52 and may have a smaller area than the long-side portion 52. The short-side portions 54 may be connected to two opposite ends of the long-side portion 52 in the longitudinal direction. The short-side portions 54 may be mounted in an upright configuration perpendicular to the long-side portion 52. The short-side portions 54 and the long-side portion 52 may be integrally formed. If the short-side portions 54 and the long-side portion 52 are integrally connected, the integrated structure may have a U-shaped cross section.

The connection portions 56 may form various shapes, as long as the connection portions 56 are located on two opposite sides of the long-side portion 52 in the width direction and interconnect the pair of short-side portions 54 while extending perpendicular to the long-side portion 52. The connection portions 56 may be mounted on two opposite sides of the long-side portion 52 in the width direction. The connection portions 56 may be mounted in an upright configuration perpendicular to the long-side portion 52.

The case 50 may include a structure configured to effectively control deformation caused by swelling of the electrode assembly 10 accommodated therein. For example, the short-side portions 54 may directly respond to deformation occurring in the stacking direction of the electrode assembly 10 and may minimize deformation of the case 50 due to the swelling phenomenon because the short-side portions 54 have a smaller area and higher rigidity than the long-side portion 52.

In some embodiments, the long-side portion 52 and the short-side portions 54 of the case 50 may be integrally formed, which may simplify the assembly process and enhance durability in an electrochemical reaction environment. In other embodiments, the short-side portions 54 and the long-side portion 52 may be joined by laser welding, an adhesive, or mechanical fastening. The short-side portions 54 and the long-side portion 52 may be designed to be flexibly adapted to various manufacturing processes.

The connection portions 56 may be located on two opposite sides of the long-side portion 52 in the width direction. The connection portions 56 may serve to protect the electrode assembly 10 and support the structural stability of the long-side portion 52 against swelling. The connection portions 56 may be mounted to cover the side surfaces of the electrode assembly 10, thereby securing the electrode assembly 10 to prevent movement of the electrode assembly 10 in the stacking direction and protecting the battery from external impact.

The design of the case 50 described above may enhance the structural stability and durability of the secondary battery 1 and effectively disperse internal pressure generated during charging and discharging, thereby preventing deterioration in the performance of the battery.

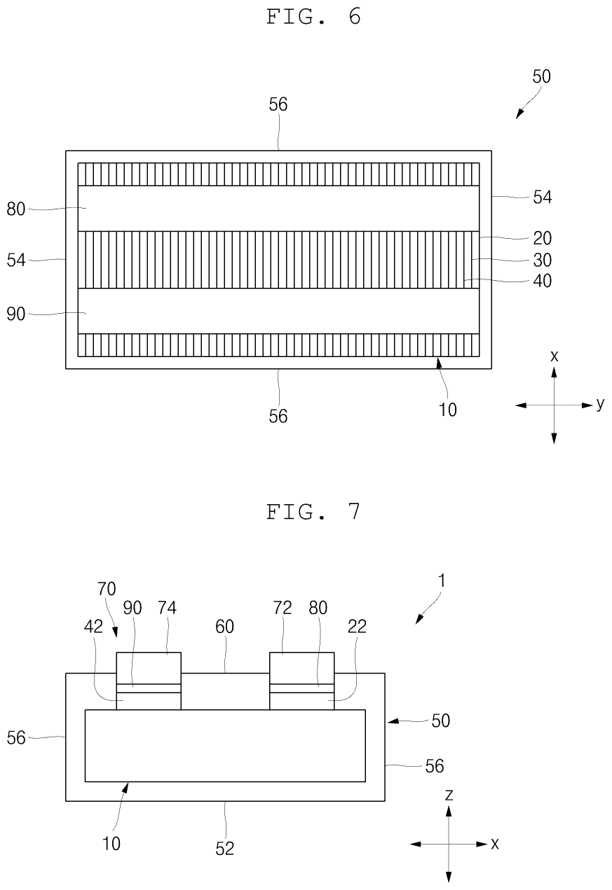

FIG. 6 is a plan view showing an example of the electrode assembly 10 mounted in the case 50 of the secondary battery 1 according to an embodiment of the present disclosure. As shown in FIG. 6, two opposite end surfaces of the electrode assembly 10 in the stacking direction may be adjacent to the short-side portions 54 of the case 50. Deformation caused by swelling of the electrode assembly 10 may primarily occur in the stacking direction of the electrode assembly 10. In consideration of this, the electrode assembly 10 may be mounted such that two opposite ends thereof in the stacking direction are adjacent to the short-side portions 54 of the case 50, which undergo relatively less deformation.

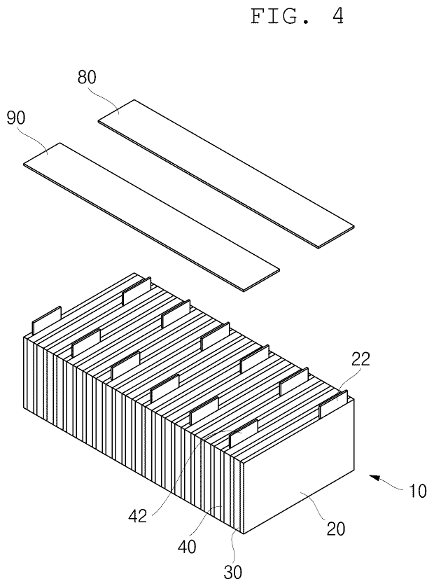

FIG. 4 is a perspective view showing an example of the electrode assembly 10, the first current collector 80, and the second current collector 90 of the secondary battery 1 according to an embodiment of the present disclosure. As shown in FIGS. 2 and 4, the first current collector 80 may be located between the electrode assembly 10 and the cap plate 60 and may extend in the stacking direction of the electrode assembly 10. The first current collector 80 may be electrically connected to the first tab 22 of the first electrode 20 and a first terminal 72 of the terminal unit 70.

In some examples, the first current collector 80 may have a rectangular plate shape. The first current collector 80 may be located above the first tab 22 and may be connected to the first tab 22 by welding. A plurality of first tabs 22 may be electrically connected to the first current collector 80. In some examples, the first current collector 80 may be formed of copper or a copper alloy.

The first current collector 80 may be made of a highly conductive material to improve current transfer efficiency. For example, to enhance electrical conductivity, a copper alloy coated with silver, gold, nickel, or an alloy thereof may be used in addition to copper or a copper alloy. These materials may contribute to reducing electrical resistance and minimizing heat generation caused by contact resistance, thereby improving the performance and lifespan of the battery.

In some embodiments, the thickness of the first current collector 80 may be designed in consideration of current transfer efficiency and mechanical strength. For example, the first current collector 80 may be formed to have a thickness of about 0.05 mm to about 0.3 mm. Although a thinner structure may contribute to weight reduction of the battery, excessive thinning may lead to reduction in mechanical strength, and therefore an appropriate balance may be required.

To enhance the bonding strength with the plurality of first tabs 22, laser welding or ultrasonic welding may be applied to the surface of the first current collector 80. These welding methods may improve mechanical strength and minimize resistance at the junction, thereby ensuring stable electrical connection.

In some examples, the shape of the first current collector 80 may be designed to align with the stacking direction of the electrode assembly 10, thereby maximizing the contact area with the electrode assembly 10. This configuration may contribute to evenly dispersing current density and preventing localized heat generation caused by excessive current concentration.

In other embodiments, the surface of the first current collector 80 may be treated with an anti-corrosion coating to maintain durability even when exposed to the electrolyte. For example, application of an oxidation-resistant coating layer or a corrosion-resistant alloy to the surface of the first current collector 80 may be employed to prevent performance degradation.

The second current collector 90 may be located between the electrode assembly 10 and the cap plate 60 and may extend in the stacking direction of the electrode assembly 10. The second current collector 90 may be formed in various shapes, as long as the second current collector 90 is electrically connected to the second tab 42 of the second electrode 40 and a second terminal 74 of the terminal unit 70. In some examples, the second current collector 90 may have a rectangular plate shape. The second current collector 90 may be located above the second tab 42 and may be connected to the second tab 42 by welding. The first current collector 80 and the second current collector 90 may be located parallel to the stacking direction of the electrode assembly 10. In some examples, the second current collector 90 may be formed of aluminum or an aluminum alloy.

The second current collector 90 may be designed to optimize electrical connection to the second electrode 40 and may be made of a highly conductive material to improve current transfer efficiency. For example, an aluminum alloy coated with nickel, silver, or an alloy thereof may be used in addition to aluminum or an aluminum alloy. These materials may contribute to enhancing electrical conductivity and providing corrosion resistance, thereby improving the durability of the battery.

The thickness of the second current collector 90 may be designed in consideration of current capacity and structural stability. For example, the second current collector 90 may be formed to have a thickness of about 0.05 mm to about 0.3 mm. This configuration may contribute to satisfying both the lightweight characteristics and the electrical performance of the battery. The combination of the thickness and the material may be optimized according to the intended usage environment.

To ensure stable electrical connection to the plurality of second tabs 42, laser welding, ultrasonic welding, or plasma arc welding may be applied to the surface of the second current collector 90. These bonding techniques may enhance mechanical strength and reduce contact resistance, thereby minimizing heat generation during current transfer.

In some examples, the second current collector 90 may be located parallel to the stacking direction of the electrode assembly 10 and designed to increase a contact area with the electrode assembly 10. This configuration may contribute to ensuring uniform distribution of current and preventing current concentration in specific regions, thereby reducing heat generation.

In other embodiments, the surface of the second current collector 90 may be treated with a rustproof or oxidation-resistant coating to enhance durability against the electrolyte. For example, corrosion resistance may be imparted by forming an aluminum oxide layer, or reactivity with the electrolyte may be minimized by applying a fluorinated coating.

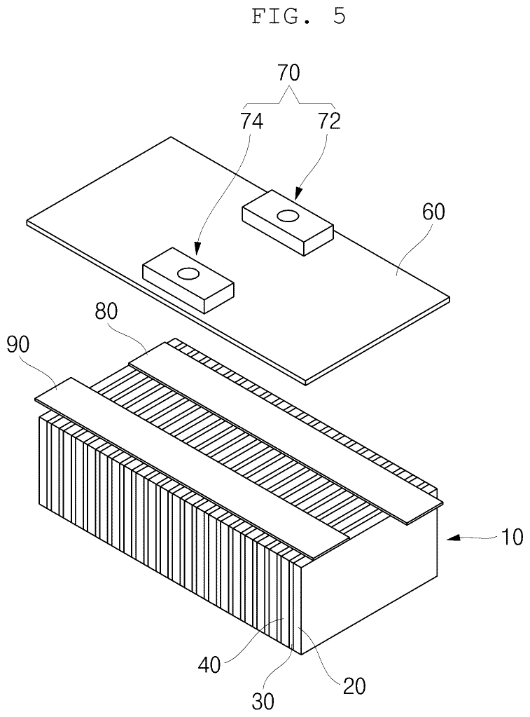

FIG. 5 is a perspective view showing an example of a state in which the first current collector 80 and the second current collector 90 are fixed to the electrode assembly 10 with the cap plate 60 separated therefrom in the secondary battery 1 according to an embodiment of the present disclosure. As shown in FIG. 5, the cap plate 60 may be coupled to the case 50 to seal the case 50.

The cap plate 60 may be formed in various shapes, as long as the cap plate 60 covers the open entrance of the case 50. In the embodiment of the present disclosure, the cap plate 60 may be formed of the same material as the case 50. For example, the cap plate 60 may be coupled to the case 50 by laser welding, but the disclosure is not limited thereto. The cap plate 60 and the long-side portion 52 may be formed to have the same or similar area.

The cap plate 60 may serve to maintain a seal between the case 50 and the electrode assembly 10 and prevent leakage of the electrolyte to the outside and introduction of external air into the case 50. To this end, the junction between the cap plate 60 and the case 50 may be designed in a structure that maximizes airtightness. For example, high-precision welding, such as tungsten inert gas (TIG) welding, metal inert gas (MIG) welding, or plasma arc welding, may be employed in addition to laser welding. In other embodiments, a sealing material may be applied to the junction to further enhance airtightness.

In some examples, the cap plate 60 may include a safety valve structure that may open at a predetermined pressure to ensure safety in the event of increase in internal pressure. The safety valve may reduce the risk of explosion by relieving pressure and enhance the safety of the battery in hazardous situations such as overcharging or application of external impact. The safety valve may be secured by welding or may be mounted using a mechanical assembly method.

The surface of the cap plate 60 may undergo additional treatment to prevent corrosion. For example, if the cap plate 60 is made of aluminum or an aluminum alloy, anodizing treatment may be applied to improve corrosion resistance and durability. In other embodiments, a fluorine or rustproof coating may be additionally applied to the metal surface to minimize reactivity with the electrolyte.

The cap plate 60 may be designed to be electrically insulated from the terminal unit 70. To this end, an insulating material may be inserted into a portion of the cap plate 60 in which the terminal unit 70 is mounted, or an insulating coating may be applied to a region of the cap plate 60 that contacts the terminal unit 70. This design may contribute to ensuring electrical stability and preventing short circuit.

In other embodiments, the cap plate 60 may be formed of a material having a suitable coefficient of thermal expansion and heat resistance to maintain airtightness without deformation in a high-temperature environment of the battery. For example, stainless steel (SUS) or a heat-resistant aluminum alloy may be used. These materials may contribute to improving the long-term reliability of the battery.

The terminal unit 70 may be mounted on the cap plate 60 and may function as a key component to connect the electrode assembly 10 to an external circuit. The terminal unit 70 may be electrically connected to the first current collector 80 and the second current collector 90 and may protrude outward from the cap plate 60 to be electrically connected to an external terminal outside the battery. The terminal unit 70 may be formed of a material having low electrical resistance and high mechanical strength to maximize current transfer efficiency.

In the embodiment of the present disclosure, the terminal unit 70 may include a first terminal 72 electrically connected to the first current collector 80 and a second terminal 74 electrically connected to the second current collector 90.

In some examples, the first terminal 72 and the second terminal 74 may be made of a highly conductive material such as copper, a copper alloy, aluminum, or an aluminum alloy. To prevent corrosion caused by the electrolyte, rustproof treatment such as nickel plating or silver plating may be additionally applied to the surfaces of the first terminal 72 and the second terminal 74. This surface treatment may contribute to ensuring long-term electrical reliability and reducing contact resistance.

The terminal unit 70 may be designed to facilitate connection to an external power supply or load. For example, the terminal unit 70 may be formed in a threaded structure, a clip-type structure, or a blade-type (flat) structure, thereby accommodating various electrical connection methods. A threaded structure may provide high fastening strength, thereby ensuring stable connection in a vibration environment such as vehicles. A clip-type structure may facilitate assembly and disassembly, making it suitable for maintenance operations.

In other embodiments, the terminal unit 70 may include an additional safety device to protect the secondary battery 1. For example, an overcurrent protection device or a fuse may be integrated into the terminal unit 70 to protect the secondary battery 1 from abnormal current. Such a protection device may contribute to enhancing electrical safety and extending the lifespan of the battery.

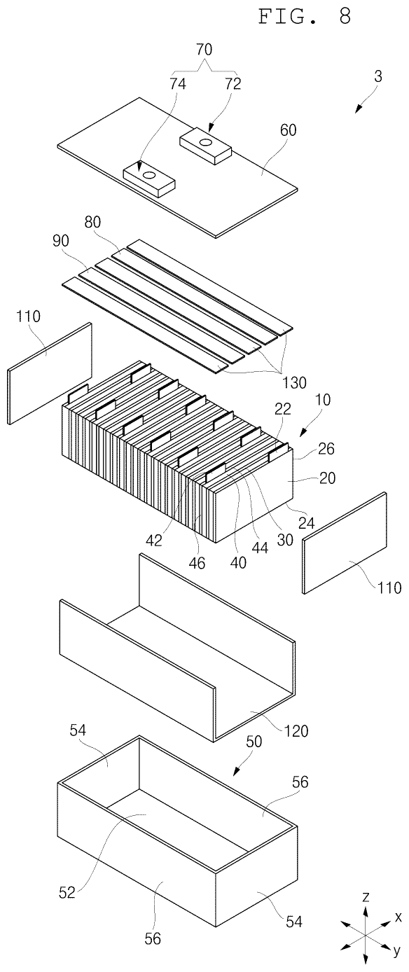

FIG. 7 is a side cross-sectional view showing an example of the secondary battery according to an embodiment of the present disclosure. As shown in FIG. 7, one side of the first terminal 72 may be connected to the first current collector 80, and the opposite side thereof may extend to the outside of the cap plate 60. Similarly, one side of the second terminal 74 may be connected to the second current collector 90, and the opposite side thereof may extend to the outside of the cap plate 60 to be connected to an external circuit. In some embodiments, the first terminal 72 and the second terminal 74 may be designed to be electrically isolated from each other, thereby ensuring insulation between the positive electrode and the negative electrode.

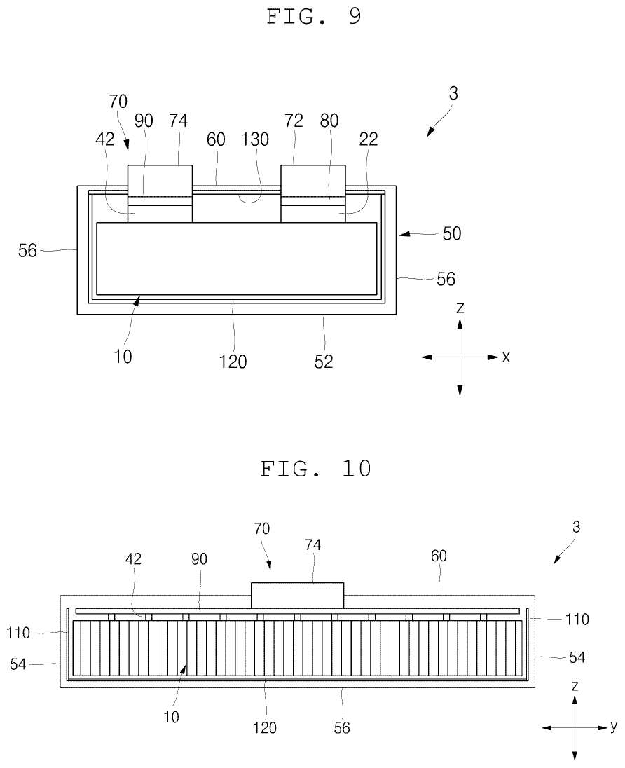

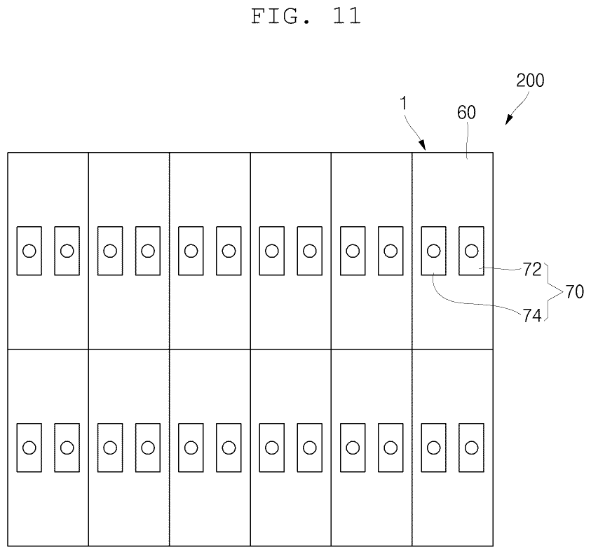

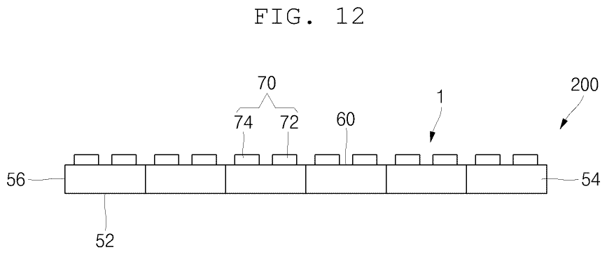

FIG. 8 is an exploded perspective view showing an example of a secondary battery 3 according to an embodiment of the present disclosure, FIG. 9 is a side cross-sectional view showing an example of the secondary battery 3 according to an embodiment of the present disclosure, and FIG. 10 is a front cross-sectional view showing an example of the secondary battery 3 according to an embodiment of the present disclosure. As shown in FIGS. 8 to 10, the secondary battery 3 according to an embodiment of the present disclosure may include an electrode assembly 10, a case 50, a cap plate 60, a terminal unit 70, a first current collector 80, a second current collector 90, and an insulating member 100.

Components other than the insulating member 100 are identical or similar to those described in the foregoing embodiment of the present disclosure, and thus detailed descriptions thereof will be omitted. The addition of the insulating member 100 may contribute to further enhancing the electrical stability, safety, and durability of the secondary battery 3.

The insulating member 100 may be mounted between the electrode assembly 10 and the case 50 and between the electrode assembly 10 and the cap plate 60, thereby ensuring electrical insulation between components within the secondary battery 3 and enabling safe operation. The insulating member 100, which is formed of an insulating material, may provide not only high insulation resistance but also excellent heat resistance and durability, making it suitable for the design of the high-power secondary battery 3.

The insulating member 100 may include an end insulating portion 110, a side insulating portion 120, and/or an inner insulating portion 130, thereby preventing electrical short circuit that may occur inside the secondary battery 3 and providing mechanical stability. The end insulating portion 110, the side insulating portion 120, and/or the inner insulating portion 130 may be made from the same materials or different materials, depending on a particular configuration.

The end insulating portion 110 may be located between the electrode assembly 10 and each of the short-side portions 54 of the case 50. The end insulating portion 110 may be made of an insulating material and formed in a plate shape.

In some examples, the end insulating portion 110 may be made of a material having excellent heat resistance and insulating properties, such as polyimide, polypropylene, or a ceramic composite material. The end insulating portion 110 may extend in the stacking direction of the electrode assembly 10 and may be mounted so as not to contact each of the short-side portions 54 of the case 50, thereby maintaining electrical insulation.

The end insulating portion 110 may serve to prevent electrical contact during swelling of the electrode assembly 10 and may further function as a mechanical buffer, thereby improving the durability of the secondary battery 3.

The side insulating portion 120 may be located between the electrode assembly 10 and the long-side portion 52 of the case 50 and between the electrode assembly 10 and the connection portions 56 of the case 50. The side insulating portion 120 may be formed in a U-shaped structure that surrounds the lower portion of the electrode assembly 10 as well as the side surfaces of the electrode assembly 10 in the width direction.

The side insulating portion 120 may serve to prevent the electrode assembly 10 from coming into electrical contact with the long-side portion 52 or the connection portions 56 and facilitate alignment during the assembly process.

In some examples, the side insulating portion 120 may be made of a flexible insulating material and designed so as not to be damaged during the assembly process. The side insulating portion 120 may absorb deformation and maintain electrical insulation performance during swelling of the electrode assembly 10.

The inner insulating portion 130 may be located between the electrode assembly 10 and the cap plate 60 to provide electrical insulation between the upper portion of the electrode assembly 10 and the cap plate 60. The inner insulating portion 130 may be formed in a rectangular plate shape and may completely cover the upper portion of the electrode assembly 10 to prevent electrical contact with the cap plate 60.

In some examples, the inner insulating portion 130 may be made of a high-strength ceramic or reinforced plastic material to maintain structural stability in a thermal runaway situation. The inner insulating portion 130 may also function to fix and align the position of the electrode assembly 10. The inner insulating portion 130 may be precisely designed so as not to overlap the first current collector 80 or the second current collector 90.

The above-described insulating member 100 may enhance the safety of the secondary battery 3, may be suitable for the design of the high-power and high-density secondary battery 3, and may effectively address electrical issues caused by the swelling and contraction of the electrode assembly 10.

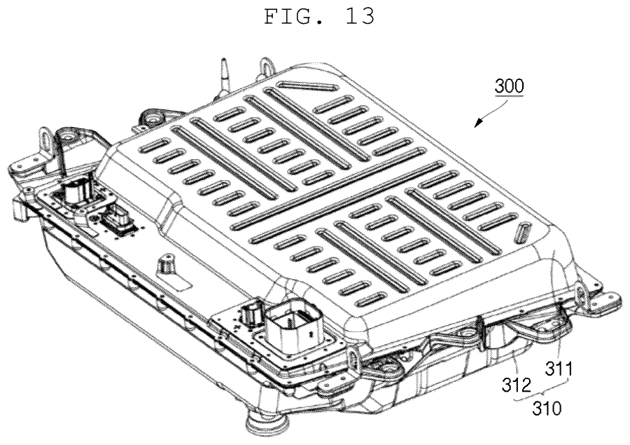

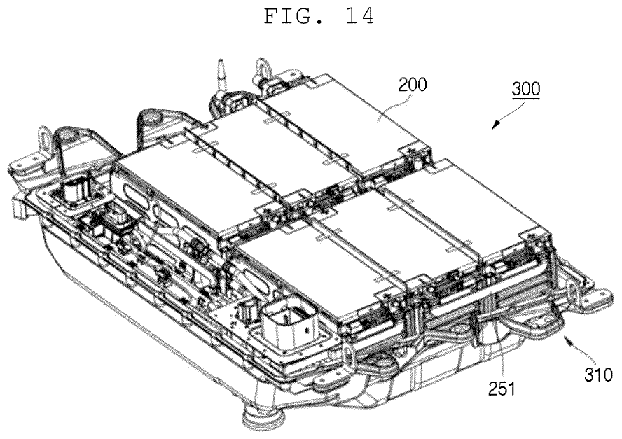

FIG. 11 is a plan view showing an example of a battery module 200 according to an embodiment of the present disclosure, and FIG. 12 is a front view showing an example of the battery module 200 according to an embodiment of the present disclosure. As shown in FIGS. 11 and 12, a plurality of secondary batteries 1 may be sequentially disposed to form the battery module 200.

If the battery module 200 is implemented using the secondary batteries 1 according to the present disclosure, swelling of the secondary batteries 1 may be effectively suppressed or mitigated, and as a result, the spacing between the secondary batteries 1 may be minimized, allowing for more compact arrangement. This configuration may allow a greater number of secondary batteries 1 to be accommodated within a given space, which may be advantageous in designing the high-power and high-capacity battery module 200.

In some examples, if the secondary batteries 1 are stacked in a single-layer structure, the battery module 200 may have a reduced thickness, enabling a lightweight design. This may contribute to improved space efficiency and energy density in mobile power devices such as electric vehicles.

In some examples, the battery module 200 may employ a frame material having excellent thermal conductivity and durability, thereby improving thermal management inside the module and maintaining stable performance during repeated cycles of charging and discharging.

In other embodiments, a bus bar or a flexible printed circuit board (FPCB) may be used to improve an electrical connection between the secondary batteries 1. This connection structure may be advantageous in evenly distributing current and reducing electrical loss.

The battery module 200 of the present disclosure may be utilized in various applications. For example, the battery module 200 may provide high reliability in applications that require high-performance power sources, such as electric vehicles, energy storage systems (ESS), and drones.

The electrode assembly 10 of the present disclosure will now be described in more detail.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<×<), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

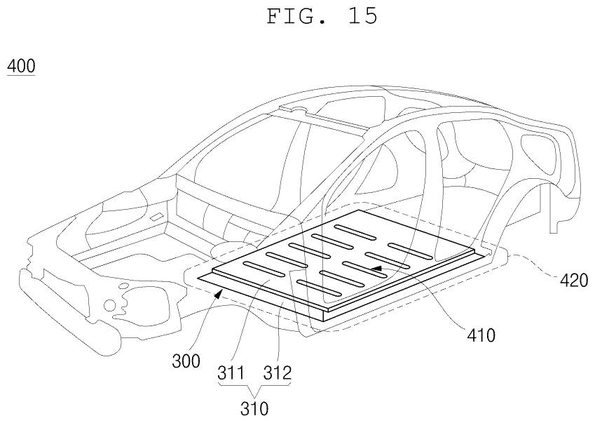

The batteries according to the above-described embodiments may be used to manufacture a battery pack. FIGS. 13 and 14 are perspective views showing a battery pack including the exemplary secondary battery according to the present disclosure. Referring to FIGS. 13 and 14, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

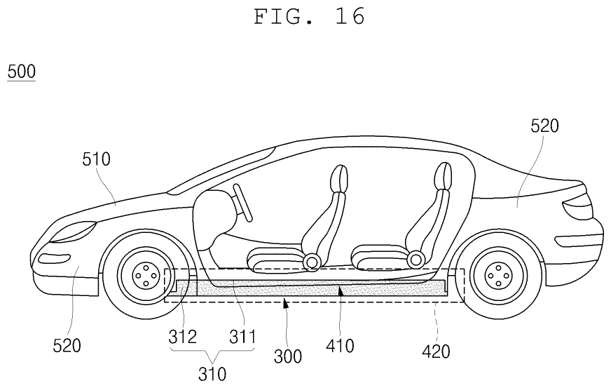

FIGS. 15 and 16 are, respectively, a perspective view and a side view showing vehicles 400 and 500 including the exemplary battery pack 300 according to the present disclosure.

In FIG. 15, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 16, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

As is apparent from the above description, secondary batteries configured as disclosed herein can effectively control and/or mitigate swelling of an electrode assembly that occurs during charging and discharging of a secondary battery by optimizing or improving the structure of a case and the arrangement of short-side portions and a long-side portion of the case in consideration of the stacking direction of the electrode assembly.

Furthermore, such secondary batteries reduce contact resistance, thereby improving current transfer efficiency, and reducing heat generation by providing current collectors between the electrode assembly and a terminal unit. Moreover, such secondary batteries can improve/optimize the electrical connection to electrode tabs.

However, the effects achievable through the present disclosure are not limited to those described above, and other technical effects not mentioned can be clearly understood by those skilled in the art from the description of the disclosure provided above.

Although a few embodiments of the present disclosure have been shown and described, it would be appreciated by those skilled in the art that various changes and modifications may be made in this embodiment without departing from the principles and technical idea of the disclosure.

What is claimed is:

1. A secondary battery comprising:
an electrode assembly comprising:
a first electrode;
a separator; and
a second electrode,
wherein the first electrode, the separator, and the second electrode are alternately stacked;
a case configured to accommodate the electrode assembly, the case comprising:
a long-side portion extending in a stacking direction of the electrode assembly; and
short-side portions connected to two opposite ends of the long-side portion, the short-side portions having a smaller area than the long-side portion;
a cap plate coupled to the case to seal the case; and
a terminal unit mounted on the cap plate and electrically connected to each of the first electrode and the second electrode,
wherein the electrode assembly comprises two opposite end surfaces perpendicular to the stacking direction and adjacent to the short-side portions of the case.

2. The secondary battery as claimed in claim 1, further comprising:
a first current collector located between the electrode assembly and the cap plate,
the first current collector extending in the stacking direction of the electrode assembly, and
the first current collector electrically connected to a first electrode tab of the first electrode and a terminal of the terminal unit.

3. The secondary battery as claimed in claim 2, wherein the first current collector has a rectangular plate shape.

4. The secondary battery as claimed in claim 2, further comprising:
a second current collector located between the electrode assembly and the cap plate,
the second current collector extending in the stacking direction of the electrode assembly, and
the second current collector electrically connected to a second electrode tab of the second electrode and a second terminal of the terminal unit.

5. The secondary battery as claimed in claim 4, wherein the second current collector has a rectangular plate shape.

6. The secondary battery as claimed in claim 4, wherein the first current collector and the second current collector are located parallel to the stacking direction of the electrode assembly.

7. The secondary battery as claimed in claim 4, wherein the first tab and the second tab protrude toward the cap plate.

8. The secondary battery as claimed in claim 4, wherein the first electrode is a positive electrode, and the second electrode is a negative electrode.

9. The secondary battery as claimed in claim 4, wherein the first current collector and the second current collector are connected to the first tab and the second tab, respectively, by welding.

10. The secondary battery as claimed in claim 1, wherein the case comprises connection portions located on two opposite sides of the long-side portion in a width direction, and wherein the connection portions are mounted perpendicular to the long-side portion, such that the connection portions interconnect the short-side portions.

11. The secondary battery as claimed in claim 1, wherein the first electrode, the separator, and the second electrode are formed in a rectangular plate shape.

12. The secondary battery as claimed in claim 11, wherein the first electrode, the separator, and the second electrode are mounted perpendicular to the long-side portion and are alternately stacked.

13. The secondary battery as claimed in claim 11, wherein the first electrode comprises a first electrode rectangular edge divided into long sides and short sides according to a length, the long sides being longer than the short sides, and
wherein one of the long sides is adjacent to the long-side portion.

14. The secondary battery as claimed in claim 11, wherein the second electrode comprises a second electrode rectangular edge divided into long sides and short sides according to a length, the long sides being longer than the short sides, and
wherein one of the long sides is adjacent to the long-side portion.

15. The secondary battery as claimed in claim 1, wherein the cap plate and the long-side portion are formed to have the same area.

16. A secondary battery comprising:
an electrode assembly comprising:
a first electrode;
a separator; and
a second electrode,
wherein the first electrode, the separator, and the second electrode are alternately stacked;
a case configured to accommodate the electrode assembly, the case comprising a long-side portion extending in a stacking direction of the electrode assembly and short-side portions connected to two opposite ends of the long-side portion, the short-sided portions having a smaller area than the long-side portion;
a cap plate coupled to the case to seal the case;
a terminal unit mounted on the cap plate and electrically connected to each of the first electrode and the second electrode; and
an insulating member mounted between the electrode assembly and the case, the insulating member further mounted between the electrode assembly and the cap plate, the insulating member being formed of an insulating material,
wherein the electrode assembly comprises two opposite end surfaces perpendicular to the stacking direction, and the two opposite end surfaces are adjacent to the short-side portions of the case.

17. The secondary battery as claimed in claim 16, wherein the insulating member comprises an end insulating portion mounted between the electrode assembly and each of the short-side portions of the case.

18. The secondary battery as claimed in claim 16, wherein the insulating member comprises a side insulating portion mounted between the electrode assembly and the long-side portion of the case, the side insulating portion further mounted between the electrode assembly and connection portions of the case.

19. The secondary battery as claimed in claim 16, wherein the insulating member comprises an inner insulating portion mounted between the electrode assembly and the cap plate

20. The secondary battery as claimed in claim 16, comprising:
a first current collector located between the electrode assembly and the cap plate, the first current collector extending in the stacking direction of the electrode assembly, the first current collector electrically connected to a first tab of the first electrode and a first terminal of the terminal unit; and
a second current collector located between the electrode assembly and the cap plate, the second current collector extending in the stacking direction of the electrode assembly, the second current collector electrically connected to a second tab of the second electrode and a second terminal of the terminal unit.
